(19) United States
(12) Patent Application Publication
(10) Pub. No.: US 2019/0296614 A1
(43) Pub. Date: Sep. 26, 2019

(54) Thermal Management Assembly for Rotor of Vehicle Electric Machine

(71) Applicant: Ford Global Technologies, LLC, Dearborn, MI (US)

(72) Inventors: Chun Tang, Canton, MI (US); Feng Liang, Troy, MI (US); Wei Wu, Northville, MI (US); Michael W. Degner, Novi, MI (US)

(73) Assignee: Ford Global Technologies, LLC, Dearborn, MI (US)

(21) Appl. No.: 15/926,410

(22) Filed: Mar. 20, 2018

(51) Int. Cl. H02K 9/193; H02K 1/27; H02K 5/20

(52) U.S. Cl. CPC H02K 9/193; H02K 5/20; H02K 1/274

(57) ABSTRACT

An electric machine assembly including a stator core and a rotor is provided. The stator core defines a cavity. The rotor is sized for insertion within the cavity and defines a plurality of magnet pockets each sized to receive a magnet in a central pocket region between an outer pocket region and an inner pocket region. The inner pocket region is a receptacle for coolant to thermally communicate with the magnet. The outer pocket region may be filled with an epoxy to prevent fluid communication between the outer pocket region and the central pocket region. The magnet may be sized such that there is no gap between the magnet and edges of the central pocket region.

### TECHNICAL FIELD

The present disclosure relates to thermal management assemblies for magnets of vehicle electric machines.

### BACKGROUND

Magnets within rotors of vehicle electric machine assemblies generate heat due to rotor operation. Increased rotor temperatures may reduce magnet performance and thus rotor performance. Typical electric machine assemblies do not include thermal management systems for magnets mounted to rotors. Existing thermal management systems for assemblies near rotor magnets are complex and may not efficiently cool the magnets. For example, existing thermal management systems may not supply coolant for direct contact with the magnets.

### SUMMARY

A vehicle electric machine rotor includes an inner region, a first magnet pocket, a magnet, and epoxy. The inner region extends radially about a rotor through-hole. The first magnet pocket is defined within the inner region and includes a central pocket region between an inner pocket region and an outer pocket region. The magnet is disposed within the central pocket region of the first magnet pocket such that a side channel is defined between an edge of the first magnet pocket and the magnet. The epoxy is disposed within the outer pocket region. The magnet is arranged with the epoxy such that coolant disposed within the inner region flows between the side channel and the inner region without leaking to an outer surface of the rotor. The magnet may include two separate pieces spaced from one another to define a central channel therebetween. The central channel may be sized for disposal of coolant therein to assist in managing thermal conditions of the two separate pieces of magnet. The rotor may further include at least one coolant reservoir in fluid communication with one of the central channels. The rotor through-hole may be sized to receive a shaft and the side channel may not be in fluid communication with the rotor through-hole. The rotor may further include a second magnet pocket spaced from the first magnet pocket to define a bridge region therebetween. The magnet may be further arranged with the epoxy such that coolant disposed within the inner pocket region directly contacts the magnet.

An electric machine assembly includes a stator core and a rotor. The stator core defines a cavity. The rotor is sized for insertion within the cavity and defines a plurality of magnet pockets each sized to receive a magnet in a central pocket region between an outer pocket region and an inner pocket region. The inner pocket region is a receptacle for coolant to thermally communicate with the magnet. The outer pocket region may be filled with an epoxy to prevent fluid communication between the outer pocket region and the central pocket region. The magnet may be sized such that there is no gap between the magnet and edges of the central pocket region. Coolant within the inner pocket region may move as influenced by a centripetal force generated by rotation of the rotor and/or a pump in fluid communication with the inner pocket region. The magnet and the inner pocket region may be arranged with one another such that the coolant directly contacts the magnet. The inner pocket region may be located adjacent a bridge region of the rotor. The bridge region may be located between adjacent magnet pockets of the plurality of magnet pockets. The rotor may be made of a stack of laminations including the plurality of magnet pockets. Each of the magnets may be arranged with a respective magnet pocket such that disposal of epoxy within the outer pocket regions prevents oil leakage to an outer rotor surface when the laminations are stacked.

A vehicle electric machine assembly includes a stator, a rotor, and a plurality of pairs of magnets. The stator defines a stator cavity. The rotor is disposed within the stator cavity and is made up of a stack of laminations. Each of the laminations defines a plurality of magnet pockets. Each of the plurality of pair of magnets is disposed within one of the plurality of magnet pockets such that the magnets of each pair of magnets are spaced from one another to define a coolant channel therebetween. Each of the laminations may further define a coolant reservoir adjacent the magnet pocket and in fluid communication with the coolant channel. Each of the plurality of magnet pockets may include a central pocket region to receive a respective pair of magnets and an outer pocket region and an inner pocket region located on opposing sides of the central pocket region. The inner pocket region may include coolant disposed therein for thermal communication with an adjacent magnet of the pair of magnets. Each of the inner pocket regions of each of one of the pair of magnets may be disposed adjacent a center bridge of the rotor. Coolant may be disposed within the coolant channel such that rotation of the rotor moves the coolant toward an outer portion of the rotor to assist in managing thermal conditions of the magnet. Each of the magnet pockets may include an inner pocket region and an outer pocket region disposed on either side of a respective pair of magnets and arranged with the respective pair of magnets such that an epoxy disposed within the outer pocket region prevents coolant leakage to an outer rotor surface when the laminations are stacked.

### BRIEF DESCRIPTION OF THE DRAWINGS

FIG. 1 is a perspective, exploded view of an example of a portion of a vehicle electric machine assembly.

FIG. 2 is a front view illustrating an example of a portion of a rotor of a vehicle electric machine assembly.

FIG. 3 is a graph illustrating an example of a comparison of operational temperature conditions of a magnet of a rotor.

FIG. 4A is a front view, in cross-section, of an example of a portion of a rotor.

FIG. 4B is a detailed front view, in cross-section, of a portion of the rotor of FIG. 4A.

FIG. 5 is a front view, in cross-section, of an example of a portion of a rotor.

FIG. 6 is a front view, in cross-section, of an example of a portion of a rotor.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

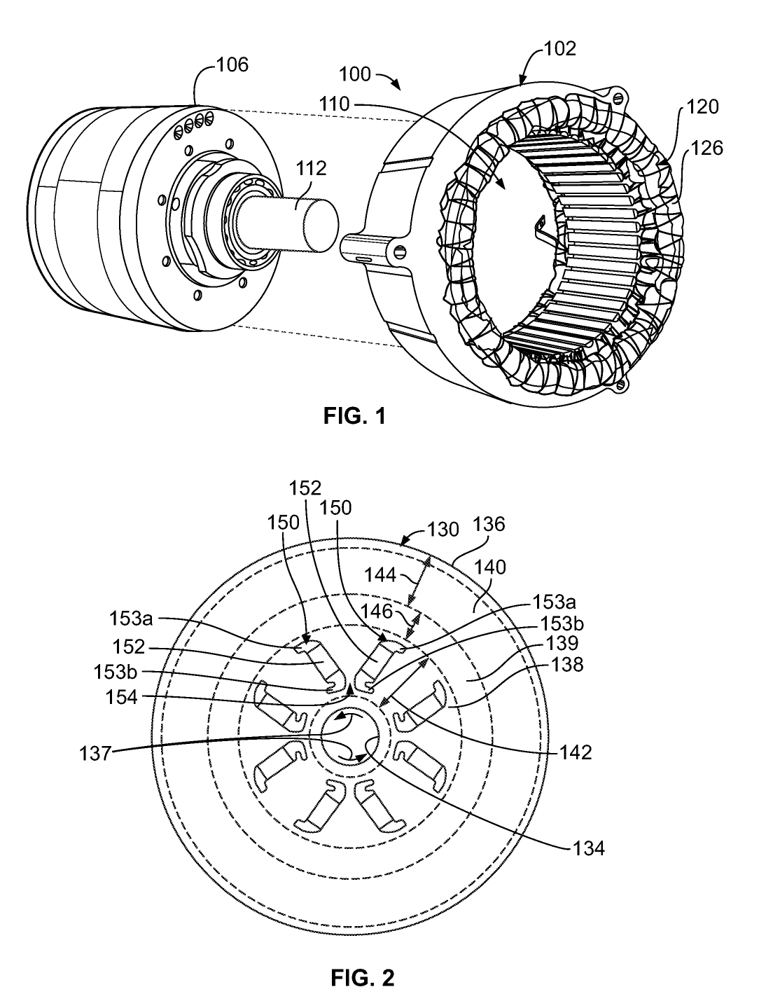

FIG. 1 is a partially exploded view illustrating an example of portions of an electric machine for an electrified vehicle, referred to generally as an electric machine 100 herein. The electric machine may include a stator core 102 and a rotor assembly 106. Electrified vehicles may include more than one electric machine. One of the electric machines may function primarily as a motor and the other may function primarily as a generator. The motor may operate to convert electricity to mechanical power and the generator may operate to convert mechanical power to electricity. The stator core 102 may define a cavity 110. The rotor assembly 106 may be sized for disposal and operation within the cavity 110 and may include a rotor comprising a stack of lamination portions. A shaft 112 may be operably connected to the rotor assembly 106 and may be coupled to other vehicle components to transfer mechanical power therefrom.

Windings 120 may be disposed within the cavity 110 of the stator core 102. In an electric machine motor example, current may be fed to the windings 120 to obtain a rotational force on the rotor of the rotor assembly 106. In an electric machine generator example, current generated in the windings 120 by may be used to power vehicle components. Portions of the windings 120, such as end windings 126, may protrude from the cavity 110. During operation of the electric machine 100, heat may be generated along the windings 120 and end windings 126. The rotor of the rotor assembly 106 may include magnets such that rotor operation in cooperation with an electric current running through the windings 120 and the end windings 126 generates one or more magnetic fields. Magnets of the rotor will magnetize and rotate with the magnetic field to rotate the shaft 112 for mechanical power.

FIG. 2 illustrates an example of a rotor of a vehicle electric machine, referred to as a rotor 130. The rotor 130 includes a central through-hole 134 sized to receive a shaft (not shown), such as the shaft 112 described above, and an outer surface 136. The shaft may be coupled to the rotor 130 for simultaneous rotation as represented by arrows 137. The rotor 130 further includes an inner region 138, a middle region 139, and an outer region 140.

The inner region 138 is located adjacent the central through-hole 134 and extends radially thereabout. The inner region 138 defines a radial length 142. An inner edge of the inner region 138 may be spaced from the central through-hole 134. The outer region 140 is located adjacent the outer surface 136 and extends radially about the central through-hole 134, the inner region 138, and the middle region 139. The outer region 140 defines a radial length 144. The middle region 139 defines a radial length 146. Openings or cutouts within the regions may provide locations for mounting components, such as magnets, and also provide reduced weight benefits.

For example, the rotor 130 may include a plurality of magnet pockets 150. In FIG. 2, the magnet pockets 150 are shown located within the inner region 138 however it is contemplated that the magnet pockets 150 may be located in the middle region 139 or the outer region 140 or may span across more than one of the regions. In this example, a lower portion of each of the plurality of magnet pockets 150 may be spaced from the central through-hole 134. A central pocket region of each of the plurality of magnet pockets 150 may be sized to receive a magnet 152. The central pocket region is located between an outer pocket region 153a and an inner pocket region 153b of the magnet pocket 150. Each of the magnets 152 may be arranged upon the rotor 130 to assist in generating power when the rotor 130 rotates. The plurality of magnet pockets 150 may be arranged in pairs such that one magnet pocket of each of a pair of adjacent magnet pockets 150 is disposed on either side of a bridge region 154 of the rotor 130.

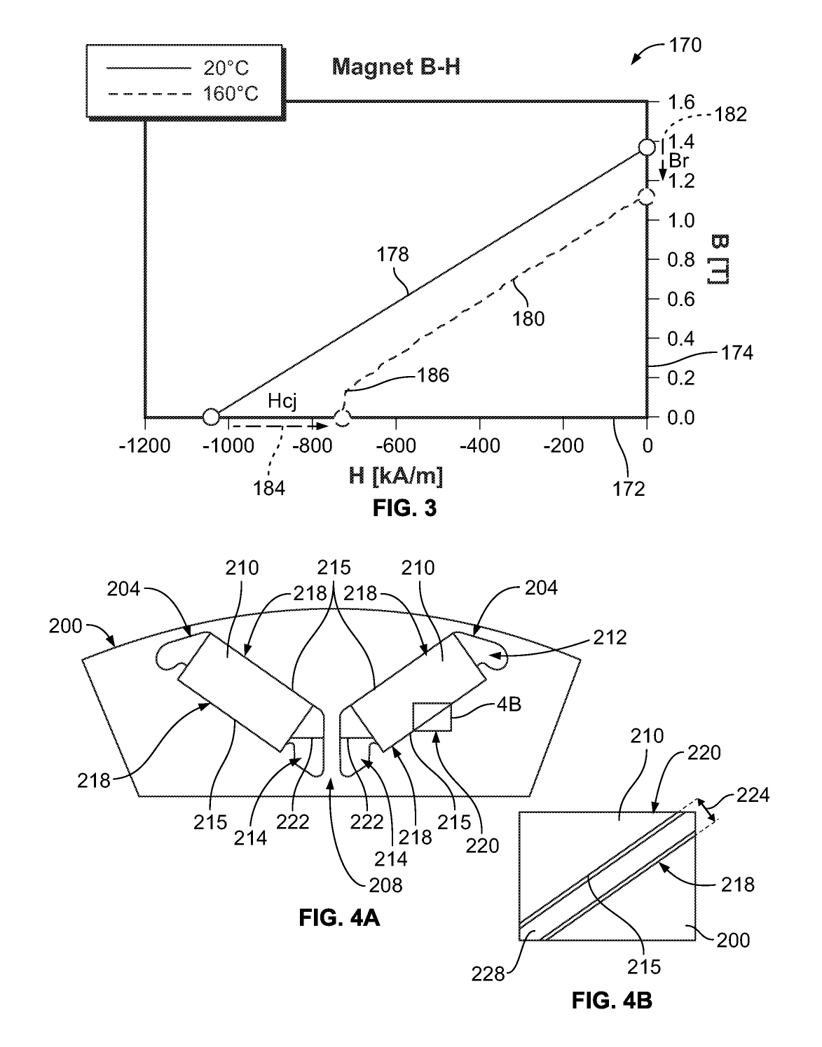

FIG. 3 is a graph illustrating an example of a comparison of operational temperature conditions relative to magnetic flux density and magnetic field strength of a magnet of a rotor of an electric machine assembly, referred to generally as a graph 170. An X-axis 172 represents a magnet magnetic field strength value in kilo Amperes/meters (kA/m). A Y-axis 174 represents a magnet flux density in Teslas (T). Plot 178 represents an operational flux density and field strength plot when an example magnet is subjected to a temperature of 20° C. Plot 180 represents an operational flux density and field strength plot when the example of the magnet is subjected to a temperature of 160° C. A linear portion of plot 180 ends at a knee-point 186 at approximately −720 kA/m. A magnet, such as the magnet 152, will begin to demagnetize at 160° C. if the magnetic field strength is higher than −720 kA/m. Arrow 182 represents a reduction in remanent flux density (Br) resulting from a change in temperature operating conditions from plot 178 to plot 180. Arrow 184 represents a reduction in coercivity resulting from the change in temperature operating conditions from plot 178 to plot 180. As shown in graph 170, subjecting a magnet to higher temperatures reduces remanent flux density and coercivity which reduces overall magnet performance. It is desirable to avoid these higher temperatures to improve magnet performance. The magnets described in relation to FIG. 2 do not have a thermal management system to assist in maintaining magnet temperature within a range to promote desirable or acceptable magnet performance.

FIG. 4A illustrates a front view, in cross-section, of a portion of an example of a rotor of a vehicle electric machine assembly, referred to as a rotor 200 herein. The rotor 200 includes a plurality of magnet pockets 204 arranged in pairs. Each of the plurality of magnet pockets 204 may be located at an inner region of the rotor 200. It is contemplated that each of the plurality of magnet pockets 204 may be located at a middle region of the rotor 200, an outer region of the rotor 200, or may span across more than one region of the rotor 200. The pairs of the plurality of magnet pockets 204 may be arranged upon the rotor 200 such that each of a pair of the plurality of magnet pockets 204 is located on one side of a bridge region 208. Each of the bridge regions 208 may be arranged with respective magnets such that magnetic flux may travel along the bridge region 208 when the rotor 200 rotates. A magnet 210 may be disposed within each of the plurality of magnet pockets 204.

For example, each of the magnets 210 may be disposed within a respective one of the plurality of magnet pockets 204 in a central pocket region between an outer pocket region 212 and an inner pocket region 214. The inner pocket region 214 is located nearer a shaft through-hole (not shown in FIG. 4A) than the outer pocket region 212. Each of the magnets 210 may be sized for disposal within the respective one of the plurality of magnet pockets 204 such that a clearance region 218 is defined between one or both major sides 215 of a respective magnet 210 and an edge of a respective one of the plurality of magnet pockets 204. As used herein, the major sides 215 of each magnet 210 are two of four of the sides of the magnet 210 having a length greater than the other two sides of the magnet 210.

FIG. 4B is a detailed view of a portion 220 of the rotor 200 shown in FIG. 4A. A portion of one of the magnets 210 is shown spaced from an edge of one of the plurality of magnet pockets 204 to define the clearance region 218. The clearance region 218 may define a dimension 224 sized, for example, based on rotor manufacturing tolerances to ensure appropriate space for insertion of the respective magnet 210. While preferable for the dimension 224 to define a length as small as practical, certain lengths of the dimension 224 may require a glue 228 for disposal within the clearance region 218 to retain a respective magnet 210 within a respective one of the plurality of magnet pockets 204 and may seal the clearance region 218.

During operation of a vehicle electric machine, a rotor, such as the rotor 200, may be rotated to assist in generating power. During rotation, one or more magnets of the rotor, such as the magnets 210, may generate heat. This generation of heat may reduce performance of the vehicle electric machine due to the heat generated by the magnets which may reduce remanent flux and coercivity as described above. The rotor 200 may include coolant in fluid communication with each magnet 210 to assist in managing thermal conditions thereof. Previous thermal management systems may have included channels for fluid communication near a respective magnet without facilitating direct contact therebetween.

In one example of the rotor 200, coolant may be disposed within each of the inner pocket regions 214. The coolant may fill a portion of a respective inner pocket region 214 as represented by fill lines 222. Each of the fill lines 222 may be located at a height relative to a lower portion of the respective inner pocket region 214 such that during rotation of the rotor 200, the coolant may move upward (e.g. toward an outer rim of the rotor 200) to contact additional portions of the respective magnet 210. Additionally, each of the outer pocket regions 212 may be filled with an epoxy such that the glue 228 and the epoxy are arranged with one another to retain the coolant within the respective inner pocket region 214 for thermal communication with the respective magnet 210. For example, the rotor 200 may be comprised of a stack of laminations. The stack of laminations may be arranged such that the inner pocket regions 214 are in registration with one another and may be in fluid communication with a pump (not shown) to move the coolant therein. Coolant disposed in the magnet pockets 204 may be more likely to leak to an outer surface of the rotor 200 if no epoxy is in the outer pocket region 212 or the coolant is not adequately sealed within the inner pocket region 214.

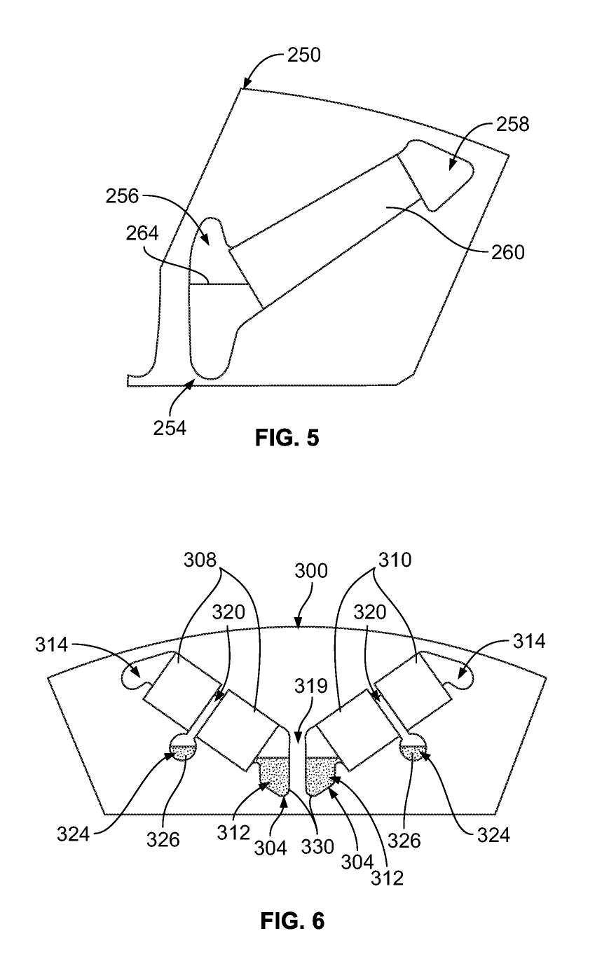

FIG. 5 illustrates a front view, in cross-section, of a portion of an example of a rotor of a vehicle electric machine assembly, referred to as a rotor 250 herein. The rotor 250 may define a plurality of magnet pockets 254 spaced radially about a shaft through-hole (not shown in FIG. 5). The rotor 250 includes a magnet pocket 254. The magnet pocket 254 includes an inner pocket region 256 and an outer pocket region 258. A magnet 260 may be disposed within a central pocket region of the magnet pocket 254 located between the inner pocket region 256 and the outer pocket region 258.

In this example, the central region of the magnet pocket 254 and the magnet 260 are sized relative to one another such that the magnet 260 fits snugly therein and no cavity or space is defined between an edge of the magnet pocket 254 and the magnet 260. Further, the outer pocket region 258 may be filled with an epoxy. Coolant may be disposed within the inner pocket region 256 as represented by a fill line 264. The fill line 264 may be at a level within the inner pocket region 256 such that the coolant contacts portions of the magnet 260 when the rotor 250 rotating.

FIG. 6 illustrates a front view, in cross-section, of a portion of an example of a rotor of a vehicle electric machine assembly, referred to as a rotor 300 herein. The rotor 300 may comprise a stack of laminations. Each lamination may include a plurality of magnet pockets 304 radially spaced about a shaft through-hole (not shown in FIG. 6). One of a pair of the magnet pockets 304 may include a first two pieces of magnet 308 and the other of the pair of magnet pockets 304 may include a second two pieces of magnet 310. Each of the first two pieces of magnet 308 and the second two pieces of magnet 310 may be disposed within a central region of a respective one of the pair of magnet pockets 304 between a respective inner pocket region 312 and a respective outer pocket region 314. Each of the pair of magnet pockets 304 may be spaced from one another to define a bridge region 319 therebetween. Magnetic flux may travel along the bridge region 319 during rotor operation. Each of the spacings between the first two pieces of magnet 308 and the second two pieces of magnet 310 may define a coolant channel 320.

The rotor 300 may define a pair of coolant reservoirs 324. Each of the pair of coolant reservoirs 324 may be in fluid communication with one of the coolant channels 320. For example, coolant 326 may be disposed within each of the coolant reservoirs 324 and/or each of the coolant channels 320. The coolant 326 may travel between a respective coolant reservoir and a respective coolant channel to assist in managing thermal conditions of a respective two pieces of magnet. Optionally, coolant 330 may be disposed in each of the respective inner pocket regions 312 to also assist in managing thermal conditions of the first two pieces of magnet 308 and the second two pieces of magnet 310.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle electric machine rotor comprising:
an inner region extending radially about a rotor through-hole;
a first magnet pocket defined within the inner region and including a central pocket region between an inner pocket region and an outer pocket region;
a magnet disposed within the central pocket region of the first magnet pocket such that a side channel is defined between an edge of the first magnet pocket and the magnet; and
an epoxy disposed within the outer pocket region,
wherein the magnet is arranged with the epoxy such that coolant disposed within the inner region flows between the side channel and the inner region without leaking to an outer surface of the rotor.

2. The rotor of claim 1, wherein the magnet comprises two separate pieces spaced from one another to define a central channel therebetween, and wherein the central channel is sized for disposal of coolant therein to assist in managing thermal conditions of the two separate pieces of magnet.

3. The rotor of claim 2, wherein the rotor further comprises at least one coolant reservoir in fluid communication with one of the central channels.

4. The rotor of claim 1, wherein the rotor through-hole is sized to receive a shaft, and wherein the side channel is not in fluid communication with the rotor through-hole.

5. The rotor of claim 1 further comprising a second magnet pocket spaced from the first magnet pocket to define a bridge region therebetween.

6. The rotor of claim 1, wherein the magnet is further arranged with the epoxy such that coolant disposed within the inner region directly contacts the magnet.

7. An electric machine assembly comprising:
a stator core defining a cavity; and
a rotor sized for insertion within the cavity and defining a plurality of magnet pockets each sized to receive a magnet in a central pocket region between an outer pocket region and an inner pocket region,
wherein the inner pocket region is a receptacle for coolant to thermally communicate with the magnet.

8. The assembly of claim 7, wherein the outer pocket region is filled with an epoxy to prevent fluid communication between the outer pocket region and the central pocket region.

9. The assembly of claim 7, wherein the magnet is sized such that there is no gap between the magnet and edges of the central pocket region.

10. The assembly of claim 7, wherein the magnet and the inner pocket region are arranged with one another such that the coolant directly contacts the magnet.

11. The assembly of claim 7, wherein the inner pocket region is located adjacent a bridge region of the rotor, and wherein the bridge region is located between adjacent magnet pockets of the plurality of magnet pockets.

12. The assembly of claim 7, wherein the rotor comprises a stack of laminations including the plurality of magnet pockets, and wherein each of the magnets is arranged with a respective magnet pocket such that disposal of epoxy within the outer pocket regions prevents coolant leakage to an outer rotor surface when the laminations are stacked.

13. A vehicle electric machine assembly comprising:
a stator defining a stator cavity;
a rotor disposed within the stator cavity and including a stack of laminations, each lamination defining a plurality of magnet pockets; and
a plurality of pairs of magnets, each pair of magnets disposed within one of the plurality of magnet pockets such that the magnets of each pair of magnets are spaced from one another to define a coolant channel therebetween.

14. The assembly of claim 13, wherein each of the laminations further defines a coolant reservoir adjacent the magnet pocket and in fluid communication with the coolant channel.

15. The assembly of claim 13, wherein each of the plurality of magnet pockets includes a central pocket region to receive a respective pair of magnets and an outer pocket region and an inner pocket region located on opposing sides of the central pocket region, and wherein the inner pocket region includes coolant disposed therein for thermal communication with an adjacent magnet of the pair of magnets.

16. The assembly of claim 15, wherein each of the inner pocket regions of each of one of the pair of magnets is disposed adjacent a center bridge of the rotor.

17. The assembly of claim 13 further comprising coolant disposed within the coolant channel such that rotation of the rotor moves the coolant toward an outer portion of the rotor to assist in managing thermal conditions of each of the pairs of magnets.

18. The assembly of claim 13, wherein each of the magnet pockets includes an inner pocket region and an outer pocket region disposed on either side of a respective pair of magnets and arranged with the respective pair of magnets such that an epoxy disposed within the outer pocket region prevents coolant leakage to an outer rotor surface when the laminations are stacked.
